(19) United States
(12) Patent Application Publication
(10) Pub. No.: US 2009/0133805 A1
(43) Pub. Date: May 28, 2009

(54) METHOD OF MANUFACTURING MULTILAYER CERAMIC SUBSTRATE

(75) Inventors: Soo Hyun Lyoo, Yongin (KR); Jong Myeon Lee, Gwachaon (KR); Eun Tae Park, Yongin (KR); Hyong Ho Kim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/276,656

(22) Filed: Nov. 24, 2008

(30) Foreign Application Priority Data
Nov. 23, 2007 (KR) 10-2007-0120470

(51) Int. Cl. B32B 37/06

(52) U.S. Cl. 156/89.11

(57) ABSTRACT

There is provided a method of manufacturing a multilayer ceramic substrate that can be easily performed with high efficiency at low cost without affecting the performance of a multilayer ceramic substrate. A method of manufacturing a multilayer ceramic substrate according to an aspect of the invention may include: printing a cutting region onto at least one of a plurality of ceramic green sheets when the plurality of ceramic green sheets are laminated to form the ceramic laminate; firing the ceramic laminate; and cutting the fired ceramic laminate along the cutting region.

### CROSS-REFERENCE TO RELATED APPLICATIONS

This application claims the priority of Korean Patent Application No. 2007-0120470 filed on Nov. 23, 2007, in the Korean Intellectual Property Office, the disclosure of which is incorporated herein by reference.

### BACKGROUND OF THE INVENTION

1. Field of the Invention

The present invention relates to methods of manufacturing multilayer ceramic substrates, and more particularly, to a method of manufacturing a multilayer ceramic substrate that can be easily performed with high efficiency at low cost without affecting the performance of a multilayer ceramic substrate.

2. Description of the Related Art

Recently, a firing process of low temperature co-fired ceramic (LTCC) is changing from a process in which shrinkage occurs along x, y, and z directions according to the related art (shrinkage firing method) to a process in which shrinkage hardly occurs in the x-y plane but shrink only occurs in a z direction (non-shrinkage firing method). This trend occurs because an X-direction dimension and a Y-direction dimension of a multilayer ceramic substrate need to be very accurate in order that various kinds of elements and ICs to be provided can be mounted onto the surface at precise positions. In general, the non-shrinkage firing method provides higher dimensional accuracy in X and Y directions than the shrinkage firing method in the related art.

To perform the non-shrinkage firing, the size of an interim product before a firing process needs to be larger than a predetermined size. The product in a larger size is advantageous in terms of mass production and material efficiency. However, a final LTCC product needs to be cut into the size of an RF module which is, for example, less than 1.5 cm or less high and wide after the firing process. However, since the LTCC product maintains the properties of ceramic, that is, high hardness and high embrittlement, after the firing process, another region except for a cutting plane may be damaged (hereinafter, referred to as “chipping”) or the entire product may be broken. Recently, a material having higher hardness has been used for the reliability of the multilayer ceramic substrate. Therefore, a problem occurring in the cutting process has been considered an important factor. To solve this problem, various kinds of methods, such as laser cutting or half cutting, have been attempted.

A multilayer ceramic substrate is cut using two main methods. First, one method of using a high-speed rotary blade is performed. Referring to FIG. 1, a ceramic laminate 10 formed by laminating fired ceramic layers 11, 12, 13, 14, 15, and 16 is cut along a cutting region C₁ by using a rotary blade 20 to thereby cut a substrate.

However, the method of using the high-speed rotary blade is originally used to cut a printed circuit board (PCB), which is an organic substrate. Therefore, when the method is used to cut a multilayer ceramic substrate, the hardness of the ceramic used to form the multi-layer ceramic substrate, is much higher than that of an internal material of the PCB, which causes a lot of problems.

First, due to the high hardness of a sintered multilayer ceramic substrate, the multilayer ceramic substrate is not cut, and a cutting speed is reduced. Second, chipping (undesirable breakage) occurs despite a slight processing error due to the embrittlement of the ceramic. Finally, since Al₂O₃, which is one of the main components of a ceramic material for the multilayer ceramic substrate, has a hardness of approximately 9, the life of the rotary blade is significantly reduced to thereby increase maintenance and repair costs.

In order to cut the sintered multilayer ceramic substrate, a laser may be used. A Co₂ laser is proposed as a laser having high power output that allows high-speed processing. It is difficult to cut the sintered multilayer ceramic substrate by breaking bonds between atoms of the ceramic material at a wavelength (approximately 10 um) of the Co₂ laser. However, the output is increased to generate heat and melt the cutting region. However, since the cutting process using the heat generated from the high-power laser cannot prevent the influence of the heat on another region other than the cutting region, the entire ceramic substrate is most likely to be damaged.

The product can be cut by using lasers emitting light at wavelengths, including ultraviolet (UV) and infrared (IR). However, since a processing speed is too slow, it is difficult to use the UV and IR lasers for mass production. In general, UV and IR lasers using Nd:YAG (Neodymium Yttrium Aluminum Garnet) sources hardly exceed a processing speed of 20 mm/sec.

Therefore, in order to overcome the drawback of the method of cutting a multi-layer ceramic substrate according to the related art, there has been a need for a cutting method used to easily perform a cutting process without affecting another region other than the cutting region of the ceramic substrate.

### SUMMARY OF THE INVENTION

An aspect of the present invention provides a method of manufacturing a multilayer ceramic substrate that can be easily performed with high efficiency at low cost without affecting the performance of a multilayer ceramic substrate.

According to an aspect of the present invention, there is provided a method of manufacturing a multilayer ceramic substrate, the method including: printing a cutting region onto at least one of a plurality of ceramic green sheets when the plurality of ceramic green sheets are laminated to form the ceramic laminate; firing the ceramic laminate; and cutting the fired ceramic laminate along the cutting region.

The printing the cutting region may include printing the organic paste onto the ceramic green sheet by using any one of screen printing and inkjet printing.

The ceramic laminate may be formed so that the cutting region on the ceramic green sheet is aligned along a lamination direction.

The organic paste may include a nonflammable organic material.

The organic paste may include a high molecular material having a high degree of polymerization.

The organic paste may further include an organic solvent.

The organic paste may include any one of organic materials selected from the group consisting of ethyl cellulose, polyvinyl butyral, metacrylate, and a mixture thereof.

The width of the cutting region may be one or two times as large as a thickness of the ceramic green sheet.

The cutting the fired ceramic laminate may be performed by applying pressure or heat to the cutting region.

The cutting the fired ceramic laminate may be performed by applying a laser to the cutting region.

Some ceramic green sheets having cutting regions printed thereon and other ceramic green sheets not having cutting regions printed thereon may be alternately laminated when the cutting regions are printed onto some of the plurality of ceramic green sheets.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a process of cutting a multilayer ceramic substrate according to the related art;

FIGS. 2A through 2F are views illustrating a method of manufacturing a multilayer ceramic substrate according to an exemplary embodiment of the invention;

FIG. 3 is a cross-sectional view illustrating a multilayer ceramic substrate according to another exemplary embodiment of the invention;

FIG. 4 is a cross-sectional view illustrating a multilayer ceramic substrate according to still another exemplary embodiment of the invention; and

FIG. 5 is a view illustrating a cross section of a fired multilayer ceramic substrate onto which cutting regions are printed according to an exemplary embodiment of the invention.

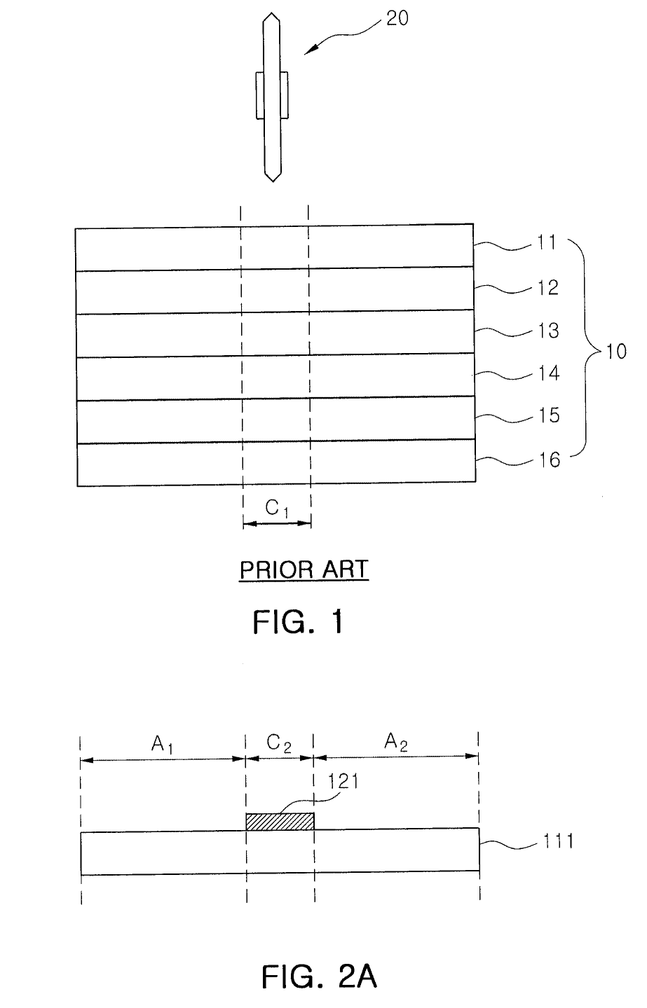

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

A method of manufacturing a multilayer ceramic substrate according to an exemplary embodiment of the invention includes: printing a cutting region onto at least one of a plurality of ceramic green sheets when the plurality of ceramic green sheets are laminated to form the ceramic laminate; firing the ceramic laminate; and cutting the fired ceramic laminate along the cutting region. In this method, organic paste is applied to a region to be cut in a ceramic green sheet, and then fired to form a void occurring when the organic paste shrinks upon heating, and a force is applied to the void to thereby cut the ceramic substrate.

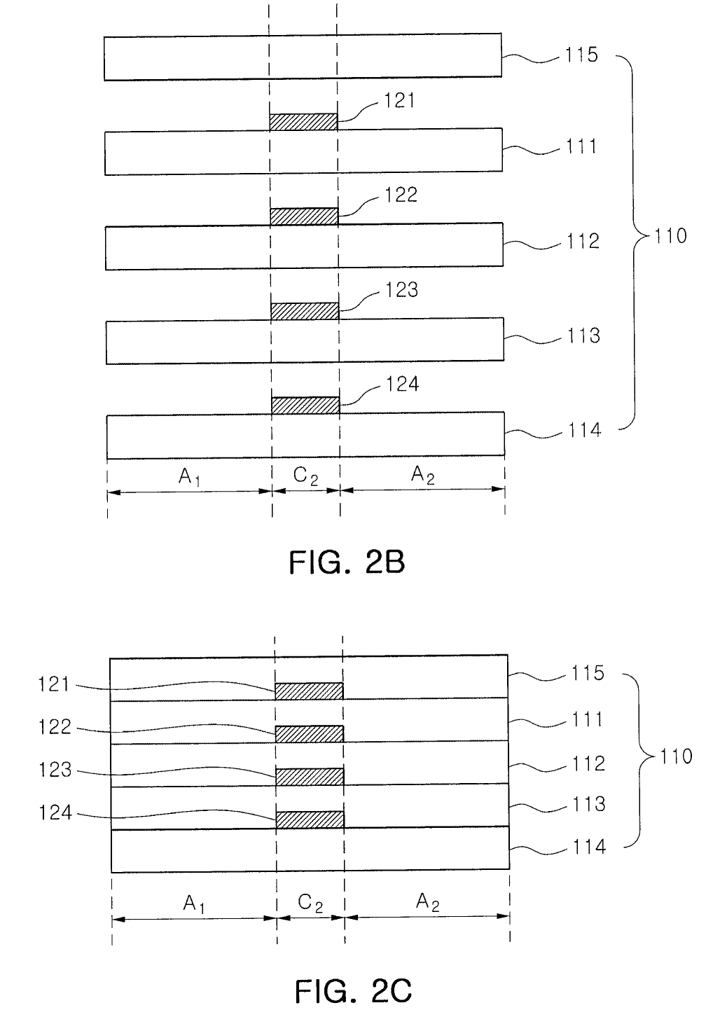

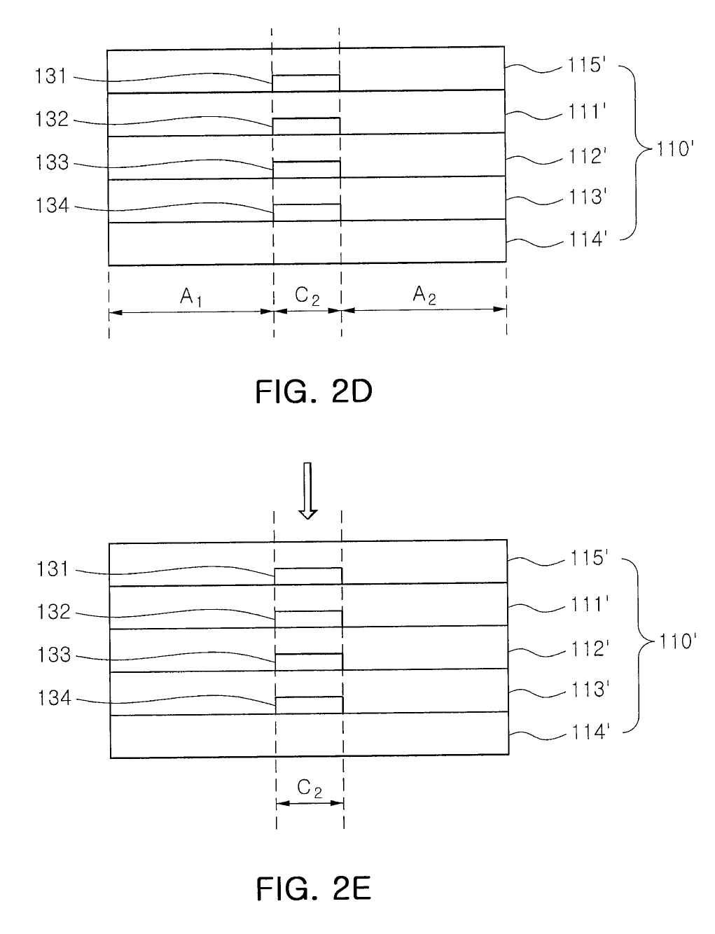

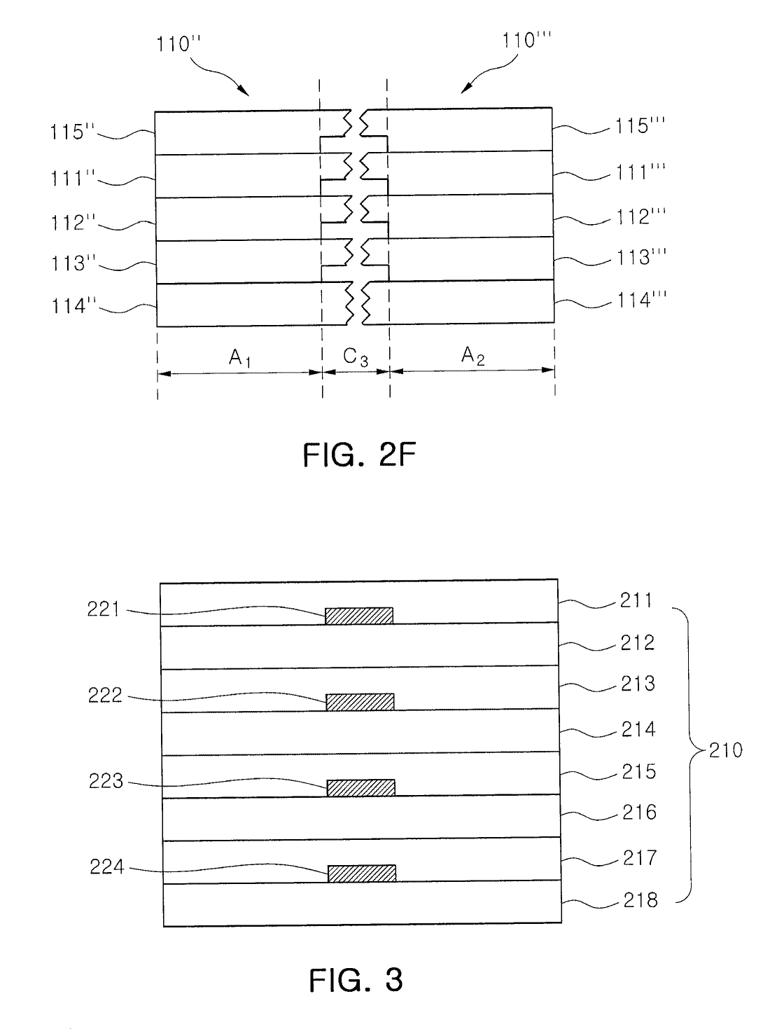

FIGS. 2A through 2F are views illustrating a method of manufacturing a multilayer ceramic substrate according to an exemplary embodiment of the invention. Hereinafter, a method of manufacturing a multilayer ceramic substrate according to an embodiment of the invention will be described with reference to FIGS. 2A through 2F.

In FIG. 2A, a ceramic green sheet 111 is shown. The ceramic green sheet 111 is divided into three regions. The ceramic green sheet 111 includes available regions A₁ and A₂ to be used and a cutting region C₂ used in a cutting process. The cutting region C₂ is formed by printing an organic paste 121 onto the ceramic green sheet 111. The ceramic green sheet 111 is manufactured using a known method. That is, ceramic powder, glass, organic binder, and other additives are mixed with a solvent to form slurry, and the slurry is molded into a sheet.

The organic paste 121 is formed of a solution containing an organic material, a solvent, and other additives. The organic material is fired together with the ceramic green sheet 111, but is burned before the ceramic green sheet 111 during the sintering of the ceramic to form a void in the cutting region C₂. However, the organic paste 121 to be printed onto the cutting region C₂ preferably contains a nonflammable organic material. When a ceramic green sheet having a relatively high firing temperature is fired, the nonflammable organic material is incompletely burned so that a void can be more easily formed. An example of the non-flammable organic material may include a high molecular substance having a high degree of polymerization. The organic paste 121 may contain an organic material added to an organic solvent, and additionally contain additives added to improve properties.

In this embodiment, the organic paste may contain any one of organic materials selected from a group consisting of ethyl cellulose, polyvinyl butyral, metacrylate, and a mixture thereof. These organic materials have a relatively high molecular weight or a high degree of polymerization, and are nonflammable organic materials.

The cutting region C₂ may have a width one or two times as large as a thickness of the ceramic green sheet 111. When the ceramic green sheet 111 has a large thickness, a large void needs to be formed to cut the ceramic green sheet 111. On the other hand, when the ceramic green sheet 111 has a small thickness, the ceramic green sheet 111 can be cut with a small void. Therefore, the width of the cutting region C₂ may be increased in proportion to the thickness of the ceramic green sheet 111. Preferably, the width of the cutting region C₂ is twice larger than the thickness of the ceramic green sheet 111. This is because a cutting process can be performed by applying a smaller force.

The organic paste 121 is printed onto a desired region of the ceramic green sheet 111 by using methods, such as screen printing or inkjet printing, so that the organic paste 121 is printed onto the cutting region C₂.

FIG. 2B, the ceramic green sheet 111, and ceramic green sheets 112, 113, and 114 onto which organic pastes 121, 122, 123, and 124 are respectively printed are prepared, and a ceramic green sheet 115 having a cutting region C₂ onto which organic paste is not applied is also prepared. Since the ceramic green sheet 115 to which the organic paste is not applied is located at an uppermost layer of the ceramic laminate, the organic paste does not need to be applied to the ceramic green sheet 115.

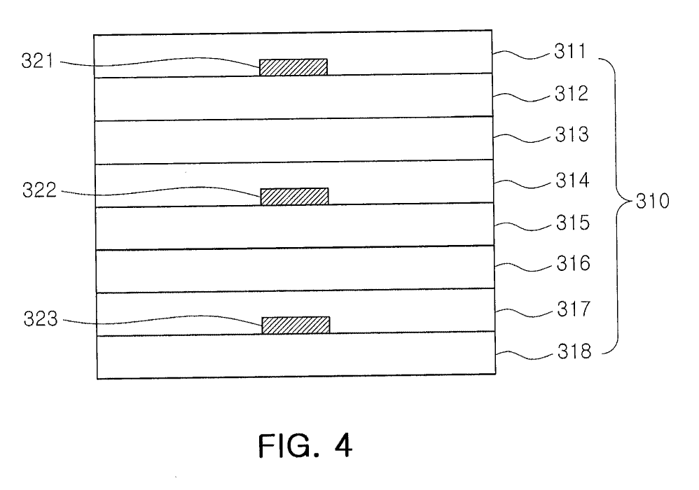

After the ceramic green sheets are prepared, the ceramic green sheets 111, 112, 113, and 114 having the cutting regions C₂ printed thereon using the organic pastes 121, 122, 123, and 124, respectively, are laminated. Then, the ceramic green sheet 115 onto which the organic paste is not printed is laminated on the uppermost layer to thereby form the ceramic laminate 110 (refer to FIG. 2C). In FIG. 2C, the organic pastes 121, 122, 123, and 124 are printed onto the four ceramic green sheets 111, 112, 113, and 114 of the ceramic laminate 110, respectively. However, the ceramic green sheet onto which the organic paste is not printed may be laminated between the ceramic green sheets onto which the organic pastes are printed. This will be described in more detail with reference to FIGS. 3 and 4. The ceramic green sheets are laminated and then bonded to each other by applying a predetermined pressure thereto. The ceramic green sheets 111, 112, 113, 114, and 115 have softness before the firing process, the organic pastes 121, 122, 123, and 124 are pressed into the ceramic green sheets 115, 111, 112, and 113, respectively.

After the ceramic laminate 110 is formed, the ceramic laminate 110 is fired at a predetermined firing temperature. The firing temperature of the ceramic laminate 110 may vary according to the ceramic powder and the glass components contained in the ceramic green sheets. In general, the ceramic powder and the glass are sintered at a low temperature within the range of 600 to 900° C. Therefore, the ceramic laminate 110 is preferably fired at this temperature. In FIG. 2D, a fired ceramic laminate 110′ is shown. The organic materials of the organic pastes 121, 122, 123, and 124 printed onto the cutting regions C₂ of the fired ceramic green sheets 111′ , 112′ , 113′ , 114′, and 115′ , respectively, are incompletely burned at the firing temperature to form voids 131, 132, 133, and 134.

A force is applied to the cutting regions C₂ of the fired ceramic laminate 110′ in which the voids 131, 132, 133, and 134 are formed. Since the force is applied to the cutting regions C₂, the ceramic green sheets are preferably laminated so that the voids are formed in the cutting regions C₂ before the firing process. Preferably, the ceramic laminate is formed so that the voids formed in the cutting regions of the ceramic green sheets are aligned along a lamination direction.

A process of cutting the multilayer ceramic substrate may be performed by applying pressure or heat to the cutting regions (refer to FIG. 2E). Alternatively, the cutting process may be performed using a laser. When the pressure, the heat or the laser is applied, the multilayer ceramic substrate can be cut by applying lower pressure or lower heat since the voids 131, 132, 133, and 134 are already formed in the cutting regions C₂ and aligned.

In FIG. 2F, two ceramic laminates 110″ and 110′″ that are cut by applying a force to the voids 131, 132, 133, and 134 of the fired ceramic laminate 110′, shown in FIG. 2E, are shown. The ceramic laminates 110″ and 110′″ are cut (C₃) around the voids without affecting the available regions A₁ and A₂.

FIG. 3 is a cross-sectional view illustrating a multilayer ceramic substrate according to another exemplary embodiment of the invention. FIG. 4 is a cross-sectional view illustrating a multilayer ceramic substrate according to still another exemplary embodiment of the invention.

The voids generated using the organic paste are not necessarily formed on all of the ceramic green sheets. The formation of the voids may be appropriately determined according to characteristics of the organic materials, a physical force applied during the cutting process, or the thickness of the ceramic green sheets. For example, after the organic material of the organic paste is fired, if it is easy to generate the voids, and the size of the generated voids is large, the organic paste may be applied to some of the ceramic green sheets. If it is difficult to generate voids or small voids are formed, the voids maybe printed on a larger number of sheets.

When cutting regions are printed onto some of the plurality of ceramic green sheets, preferably, some ceramic green sheets onto which the cutting regions are printed and other ceramic green sheets onto which the cutting regions are not printed are alternately laminated. The generated voids are evenly distributed in the entire ceramic laminate to uniformly apply a force to the entire ceramic laminate.

In FIG. 3, a ceramic laminate 210 is formed in such a way that ceramic green sheets 212, 214, 216, and 128 onto which organic pastes 221, 222, 223, and 224 are printed and ceramic green sheets 211, 213, 215, and 217 onto which organic pastes are not printed alternate with each other. The cutting regions are aligned in a lamination direction. The ceramic green sheets onto which the organic pastes are not printed are located between the ceramic green sheets having the organic pastes printed thereon. Therefore, the number of printing processes can be reduced as compared to when the cutting regions are printed onto all of the ceramic green sheets in the ceramic laminate. Accordingly, the ceramic laminate 210 can be formed by using a simplified process while saving organic paste.

FIG. 4 is a view illustrating a multilayer ceramic laminate formed by alternating one sheet onto which organic paste is printed and two sheets onto which organic paste is not printed. The two ceramic green sheets 313 and 314 not having the organic paste printed thereon are laminated on the ceramic green sheet 315 having the organic paste 322 printed thereon. The two ceramic green sheets 316 and 317 not having the organic paste printed thereon are laminated on the ceramic green sheet 318 having the organic paste 323 printed thereon. The ceramic green sheet 311 not having the organic paste printed thereon is laminated on the uppermost layer. Like the ceramic laminate 210, shown in FIG. 3, a ceramic laminate 310, shown in FIG. 4, can reduce the use of materials and the number of printing organic paste onto the ceramic green sheets. However, as compared with when cutting regions are printed onto all of the ceramic green sheets, the number of voids is reduced. The force applied to the cutting regions or the number of cutting regions needs to be increased.

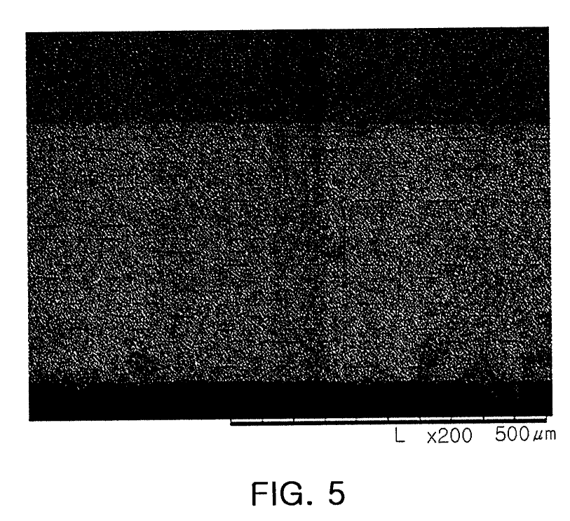

FIG. 5 is a view illustrating a cross section obtained by cutting a fired multilayer ceramic substrate having cutting regions printed thereon. In FIG. 5, the multilayer ceramic substrate has a relatively smooth section, and substrate damage or another damaged region caused by chipping or the like is not found.

As set forth above, according to exemplary embodiments of the invention, a void generated from an organic material inside a sintered ceramic substrate is formed in a cutting region in a method of manufacturing a multilayer ceramic substrate. Therefore, a desired cutting region can be only cut without using expensive equipment, such as a high-power laser or a rotary blade in the related art. Further, since a physical force is not applied to a ceramic substrate during a cutting process, product reliability can be maintained.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a multilayer ceramic substrate, the method comprising:
printing a cutting region onto at least one of a plurality of ceramic green sheets when the plurality of ceramic green sheets are laminated to form the ceramic laminate;
firing the ceramic laminate; and
cutting the fired ceramic laminate along the cutting region.

2. The method of claim 1, wherein the printing the cutting region comprises printing the organic paste onto the ceramic green sheet by using any one of screen printing and inkjet printing.

3. The method of claim 1, wherein the ceramic laminate is formed so that the cutting region on the ceramic green sheet is aligned along a lamination direction.

4. The method of claim 1, wherein the organic paste comprises a nonflammable organic material.

5. The method of claim 1, wherein the organic paste comprises a high molecular material having a high degree of polymerization.

6. The method of claim 1, wherein the organic paste further comprises an organic solvent.

7. The method of claim 1, wherein the organic paste comprises any one of organic materials selected from the group consisting of ethyl cellulose, polyvinyl butyral, metacrylate, and a mixture thereof.

8. The method of claim 1, wherein a width of the cutting region is one or two times as large as a thickness of the ceramic green sheet.

9. The method of claim 1, wherein the cutting the fired ceramic laminate is performed by applying pressure or heat to the cutting region.

10. The method of claim 1, wherein the cutting the fired ceramic laminate is performed by applying a laser to the cutting region.

11. The method of claim 1, wherein some ceramic green sheets having cutting regions printed thereon and other ceramic green sheets not having cutting regions printed thereon are alternately laminated when the cutting regions are printed onto some of the plurality of ceramic green sheets.
